(19) United States
(12) Patent Application Publication
(10) Pub. No.: US 2025/0094777 A1
(43) Pub. Date: Mar. 20, 2025

(54) AUTOMATED SELECTION OF EMBEDDING AND GENERATIVE MODELS WITH VECTOR STORE

(71) Applicant: Oracle International Corporation, Redwood Shores, CA (US)

(72) Inventors: Anatoly Yakovlev, Hayward, CA (US); Sandeep R. Agrawal, San Jose, CA (US); Karoon Rashedi Nia, Vancouver (CA); Ridha Chahed, Redwood City, CA (US); Sanjay Jinturkar, Basking Ridge, NJ (US); Nipun Agarwal, Saratoga, CA (US)

(21) Appl. No.: 18/821,539

(22) Filed: Aug. 30, 2024

Related U.S. Application Data
(60) Provisional application No. 63/583,172, filed on Sep. 15, 2023.
(60) Provisional application No. 63/583,154, filed on Sep. 15, 2023.

(51) Int. Cl. G06N 3/0455

(52) U.S. Cl. CPC G06N 3/0455

(57) ABSTRACT

The present disclosure relates to LLM orchestration with vector store generation. An embeddings model may be selected to generate an embedding for a digital artifact. Metadata for the digital artifact may also be generated and stored in a vector store in association with the embedding. A user query may be received and categorized. One of a plurality of machine learning models may be selected based on the categorization of the user query. A prompt may be generated based at least in part on the user query, and the selected machine learning model may generate a response to the user query based at least in part on the prompt.

### RELATED APPLICATION DATA AND CLAIM OF PRIORITY

This application claims the benefit of U.S. Provisional Application No. 63/583,172 entitled “Automated Orchestration Of Autonomous Agents Based On Large Language Model (LLM) In Heatwave AutoML”, filed Sep. 15, 2023, and U.S. Provisional Application No. 63/583,154 entitled “Automatic Selection Of Embedding Models And Metadata Extraction Using HeatWave AutoML And Vector Store”, filed Sep. 15, 2023 the contents of which are incorporated by reference for all purposes as if fully set forth herein.

### TECHNICAL FIELD

The present disclosure relates to orchestration of machine learning models.

### BACKGROUND

To accomplish a task using a large language model (LLM), a user must navigate an exorbitant number and variety of available, vision, and other adversarial generative models (AGMs). This is especially true for answering questions about a specific document or digital artifact. For example, given a doctor's hand-written note, one has to first convert the note to computer-understandable text and then tokenize it. Then, the tokens can be vectorized and stored in a vector database.

Each of the steps requires a separate embedding, OCR, vision, or other model. If, however, the originating file is an audio recording of doctor's notes, then it first has to be converted from audio to text and processed via tokenization, vectorization, and stored in a vector database. This requires a completely different set of models. Additionally, each of the digital artifacts can have a variety of sub-artifacts, such as tables or graphs in a PDF file. Those, too, require a separate set of models.

In addition, when a user queries the vector database for information concerning the note, the information must be extracted from the vector database, an appropriate LLM selected, and a prompt generated and provided as a natural language answer. The appropriate LLM, however, will vary based on the domain of the user query, so the user must select the LLM that best fits the user's task. Each of the numerous LLMs will also have several different hyperparameters like temperature or maximum output token limit that a user may need to configure. It can also be unclear where the LLM should obtain the information used to generate an answer. On the one hand, the LLM could find the data it needs from a publicly-available corpus of data, such as the corpus on which the LLM was trained. On the other hand, the LLM might need to search for the information in a proprietary vector store, which itself may be connected to several other vector stores. Needing to make the correct selections can make the process difficult and tedious for users and may produce suboptimal results if the wrong selections are made.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates a block diagram depicting an example of a network environment 100 according to various embodiments of the present disclosure.

FIG. 2 is a flow diagram that depicts an example of the operation of a portion of an accelerator cluster, in an embodiment.

FIG. 3 is a flow diagram that depicts an example of the operation of a portion of an accelerator cluster, in an embodiment.

FIG. 4 is a block diagram that illustrates a computer system upon which an embodiment of the invention may be implemented.

FIG. 5 is a block diagram of a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The present disclosure relates to LLM orchestration with vector store generation. Disclosed herein are approaches for automatically selecting an embeddings model to embed one or more artifacts. Given an artifact to be embedded, an embeddings selector may select an appropriate embedding modality, embeddings model, and hyperparameters for the embeddings model. Potential embeddings models may be evaluated using reconstruction error. The selected embeddings model may then embed the artifact and store the embeddings in a vector store. When generating embeddings, the selected embeddings model may also extract context and metadata from the artifact being embedded. The selected embeddings model may generate an embedding and topic and subtopic categorization metadata tree for efficient retrieval from the vector store. A topic and subtopic for an artifact may be selected using, for instance, one-shot classification.

The disclosed approaches provide improved end-to-end use of LLMs based on a similarity search on data retrieved from vector store databases. Micro-LLMs may be used to determine a topic and subtopic of a user's query. These micro-LLMs may be fine-tuned on particular topics, such as energy, medicine, or finance. They can also distinguish subtopics, e.g., internal medicine vs. abdominal surgery. The micro-LLMs are efficient because they are pruned to remove other domain knowledge The micro-LLMs may produce top k output with confidence level, and the topic and subtopic may be selected based on the confidence level. And based on confidence within a topic and subtopic, the micro-LLM can determine whether to use the vector store or an LLM's generalized knowledge to generate a response to the query. When the vector store is used, the topic and subtopic categorizations of the query and of the embeddings may speed up data retrieval. Given a particular topic and subtopic, a particular part of the vector store related to that topic and subtopic can be used for retrieval. The micro-LLMs may generate a retrieval prompt by applying a template to the query to effectively extract data from LLM or vector store. The micro LLMs may generate a response prompt based on the query, topic and subtopic categorization, embeddings, and metadata related to the embedded data. The micro-LLMs may select an appropriate LLM for the topic and subtopic categorization to generate a natural language response back to the user.

### System Overview

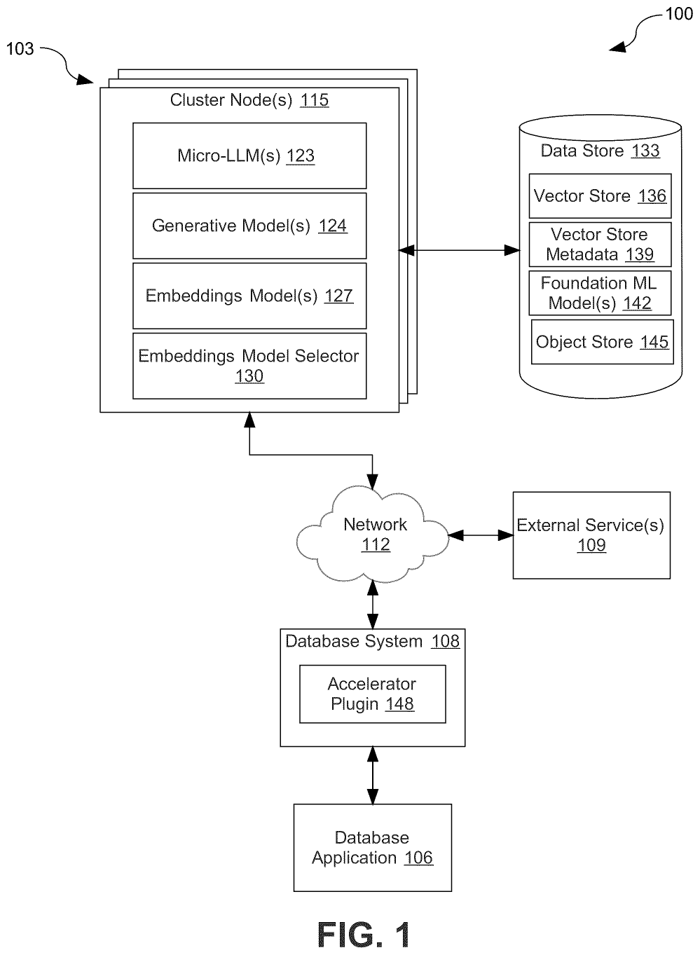

FIG. 1 illustrates a block diagram depicting an example of a network environment 100 according to various embodiments of the present disclosure. The network environment 100 may include an accelerator cluster 103, a database application 106, a database system 108, one or more external services 109, and potentially other components in communication via a network 112.

The network 112 includes the Internet, intranets, extranets, wide area networks (WANs), local area networks (LANs), wired networks, wireless networks, other suitable networks, or any combination of two or more such networks. The networks may include satellite networks, cable networks, Ethernet networks, and other types of networks.

The accelerator cluster 103 may include one or more cluster nodes 115. Each cluster node 115 may include a computing device, such as a server computer, that provides computing capabilities. Alternatively, a cluster node 115 may employ multiple computing devices that are arranged in one or more server banks or computer banks. In one example, cluster nodes 115 of the accelerator cluster 103 may be located in a single installation. In another example, the cluster nodes 115 for the accelerator cluster 103 may be distributed among multiple different geographical locations. In one case, the accelerator cluster 103 may include multiple cluster nodes 115 that together may form a hosted computing resource or a grid computing resource. In addition, the cluster nodes 115 of the accelerator cluster 103 may operate as an elastic computing resource where the allotted capacity of computing-related resources, such as processing resources, network resources, and storage resources, may vary over time. In other examples, cluster nodes 115 of the accelerator cluster 103 may include or be operated as one or more virtualized computer instances that may be executed to perform the functionality that is described herein. When used herein, the phrase “the cluster node 115” may mean any one or more of the cluster nodes 115. In addition, any functionality disclosed herein that is described as performed by “a cluster node 115”, “the cluster node 115”, or any component thereof may likewise be performed by some or all of the cluster nodes 115 in parallel.

Various applications or other functionality may be executed in the cluster node 115. Components executed in the cluster node 115 may include one or more micro-LLMs 123, one or more generative models 124, one or more embeddings models 127, an embeddings model selector 130, and other applications, services, processes, systems, engines, or functionality not discussed in detail herein.

In addition, various data may be stored in a data store 133 that is accessible to the cluster node 115. The data store 133 may be representative of a plurality of data stores. The data stored in the data store 133 may be associated with the operation of the various applications or functional entities described below. Data stored in the data store 133 may include, for example, a vector store 136, vector store metadata 139, foundation machine learning model(s) 142, and potentially other data.

The database application 106 may issue queries for the accelerator cluster 103 via the database system 108. Results of queries from the accelerator cluster 103 may be provided to the database application 106 by the database system 108.

The database system 108 may handle queries from the database application 106. The database system 108 includes an accelerator plugin 148. The accelerator plugin 148 may be used for cluster management, query scheduling, and returning query results to database system 108.

The one or more external services 109 may represent one or more service providers of natural language solutions. The one or more external services 109 may host one or more large language models. These large language models may be used to generate responses to user queries instead of or in addition to the generative models 124.

### Accelerator Cluster

The accelerator cluster 103 may represent a distributed data cluster configured to process natural language queries. The accelerator cluster includes the one or more cluster nodes 115. In some implementations, accelerator cluster 103 may use data size reduction and compression algorithms to speed up retrieval of data from the vector store 136 and of similarity search on the retrieved data. The accelerator cluster 103 may use fast data loading to retrieve data from the data store 133 at near-network speeds. This fast data loading in combination with the distributed nature of the accelerator cluster 103 may result in increased performance in performing similarity searches on data retrieved from the vector store 136. The one or more cluster nodes 115 of the accelerator cluster 103 may optimize the process of responding to natural language queries, which may be pleasingly parallel in nature. Thus, each of the one or more cluster nodes 115 may operate independently on a portion of the query.

### Vector Store and Vector Store Metadata

The vector store 136 may include tokenized and vectorized representations of documents from the object store 145 in vectorized form. Documents stored in the object store 145 may comprise unstructured data. The different types of documents may include, for example, Portable Document Format (PDF) documents, rich text documents, handwritten text documents, images, audio recordings, and videos. Documents from the object store 145 may be converted to embeddings stored in the vector store 136 by an embeddings model 127.

The vector store 136 may be any data store capable of storing vectors representing data points in a multi-dimensional space. The vector store 136 may comprise embeddings of documents from the object store 145. The vector store 136 may be divided into one or more sub-stores. In some implementations, each sub-store may include a data related to a particular topic and subtopic categorization.

The embeddings may comprise vector representations that map objects to points in a vector space. In particular, the embeddings may comprise encoded representations of the documents in the object store 145. The vector store 136 may index embeddings to the documents stored in the object store 145. In general, such indexes index embeddings or vector according to similarity. One approach for indexing embeddings and retrieving similar content using the index is HNSW (Hierarchical Navigable Small World). An example of vector store is described in U.S. Patent Application No. 63/583,298, filed by Shasank Kisan Chavan, et. al. on Sep. 17, 2023 and U.S. Patent Application No. 63/563,926, filed by Tirthankar Lahiri, et. al. on Mar. 11, 2024; the content of each these applications are incorporated herein by reference.

The vector store metadata 139 may be used to engineer a prompt for retrieving data from the vector store 136, accurately identifying similar data, and generating responses in various modalities. The vector store metadata 139 may include context and metadata associated with the embeddings stored in the vector store 136 and the corresponding documents stored in the object store 145. The vector store metadata 139 can comprise a hierarchy of document-level categorizations with multiple topics and subtopics. The vector store metadata 139 may be extracted from documents in the object store 145 during the process of vectorization and tokenization. Each document may include one or more segments representing individual paragraphs, sentences, or other subdivisions of the document. For each segment represented in the vector store 136, the vector store metadata 139 may include a label or other indicator that categorizes the segment into one or more of a plurality of topics and subtopics. The vector store 136 may be searched based on the topic and subtopic categorizations from the vector store metadata 139 to locate the relevant data.

Data size reduction and compression algorithms may be used to speed up embeddings model evaluation, retrieval of data from the vector store 136, and similarity search of the retrieved data.

### Selecting an Embeddings Model to Embed Documents

The embeddings model selector 130 may select one of a plurality of embeddings models 127 to convert one or more documents from the object store 145 into embeddings to be stored in the vector store 136. The selected embeddings model 127 may also extract, from the one or more documents being embedded, context and metadata to be stored in the vector store metadata 139. An appropriate embeddings model 127 may be selected based on, for instance, their support for a data type of the document to be embedded, whether they are pretrained on a topic and subtopic categorization of the document, and a scoring metric.

### Embeddings Models

The embeddings models 127 may be machine learning models configured to convert documents from the object store 145 into embeddings that are stored in the vector store 136. Each of the one or more embeddings models 127 may support a different data type, such as, for instance, text, image, audio, or video data. Likewise, each embeddings model 127 may be pretrained on a particular topic and subtopic in which data in documents from the object store 145 may be categorized.

In addition, the embeddings models 127 may be used to embed a query to generate a query vector. The query vector may be in a same vector space as the embeddings stored in the vector store 136. The query vector may form part of a retrieval prompt used to query the vector store 136.

### Embeddings Models and Document Data Type

To generate an embedding for a particular document, the embeddings model selector 130 may identify one or more embeddings models 127 that support the data type of the particular document. Each of the one or more embeddings models 127 may support a different data type, such as, for instance, text, image, audio, or video data. As an example, given video recording document, the embeddings model selector 130 may identify any of the embeddings models 127 that are capable of generating embeddings for video data. Any embeddings models 127 that are not capable of generating embeddings for video data may be eliminated as potential selections. As another example, given a text document, the embeddings model selector 130 may identify any of the embeddings models 127 that are capable of generating embeddings for text data. The embeddings model selector 130 would likewise eliminate any embeddings models 127 incapable of embedding text. But if a text document includes rich text-including, for instance, tables or charts—the embeddings model selector 130 may identify only embeddings models 127 that are capable of embedding rich text. In such cases, the embeddings model selector 130 would also eliminate embeddings model 127 that are generally capable of embedding text but incapable of embedding rich text. As a further example, given a text document in a specific language such as English or Spanish, the embeddings model selector 130 may identify only embeddings models 127 that support the specific language.

### Embeddings Models and Document Topic and Subtopic Categorization

Given one or more embeddings models 127 that support a document's data type, the embeddings model selector 130 may identify one or more of those embeddings models 127 that are pretrained on a topic and subtopic in which data in the particular document may be categorized. To that end, the embeddings model selector 130 may determine topic and subtopic categorizations for documents. Categorizing a document by topic and subtopic enables efficient retrieval of the document's corresponding embedding from the vector store 136. A topic and subtopic categorization for an embedding may be selected using, for example, one-shot classification.

To give an example, if the embeddings model selector 130 determines that a document is a medical text document, the embeddings model selector 130 may identify one or more embeddings models 127 that are pretrained for the medical topic among embeddings models 127 that are capable of embedding textual data. Any embeddings models 127 that are not pretrained for the medical topic may be eliminated as potential selections.

### Scoring Embeddings Models

From the remaining embeddings models 127—those that support the particular document's data type and are trained on the particular document's topic and subtopic—the embeddings model selector 130 may select an embeddings model 127 to embed the particular document using a scoring metric. The scoring metric may represent how accurately an embeddings model 127 can convert the particular document to a vector representation. The embeddings model selector 130 may determine a score for each remaining embeddings models 127 and select an embeddings model 127 with the best score. The selected embeddings model 127 may be used to generate embeddings for the particular document.

In some implementations, the scoring metric can be based at least in part on, for example, reconstruction error. When using reconstruction error, the embeddings model selector 130 can cause an embeddings model 127 to generate embeddings for the particular document. The embeddings may then be input into a decoder that is pretrained on the same topic and subtopic as the embeddings model 127. The decoder can decode the embeddings in an attempt to reconstruct the un-embedded document. The decoded embeddings may be compared to the un-embedded document to determine the extent to which the two differ, or the reconstruction error. The embeddings model 127 with the smallest reconstruction error may be selected.

In some implementations, the scoring metric may be based at least in part on metadata for the particular document-such as, for example, the document's file extension, data type, or topic and subtopic. The score may be dependent on hardware, software, and environment configuration factors. Such factors may include, for example, the number of cluster nodes 115 or service level agreement (SLA) guarantees for performance, response time, or other criteria. The number of cluster nodes 115 may be a factor because, with fewer cluster nodes 115, a quantized embeddings model 127 may be preferable for more efficient resource usable.

### Generating Embeddings for Documents

The selected embeddings model 127 may be used to convert documents stored in the object store 145 into embeddings, as well as to extract context and metadata of the documents for the vector store metadata 139.

The context and metadata extracted from the document may depend on a data type of the document. For example, from a text document, the extracted context and metadata may be based at least in part on a summary of each paragraph of text. Summaries may be generated by machine learning models trained on the topic and subtopic of the document. As another example, from an image document, the extracted context and metadata may be based at least in part on segments of the image or objects within the image. As a further example, from a video document, extracted context and metadata may be based at least in part on segments or objects in the individual frames of the video.

Using the vector store metadata 139, embeddings may be grouped within the vector store 136 based on their similarity. Groups of embeddings may be assigned labels based on their topic and subtopic according to their associated metadata from the vector store metadata 139. For example, embeddings for documents related to “abdominal surgery” may be grouped together and assigned a label indicating that they deal with abdominal surgery. A micro-LLM 123 may compare these labels with the topic and subtopic categorization of a user query to determine where in the vector store 136 to retrieve data related to the query. As an example, after categorizing the query “What are the risks of an appendectomy” into the “medical” topic and “abdominal surgery” subtopic, the micro-LLM 123 may identify embeddings with the “abdominal surgery” label in the vector store 136.

### Selecting a GENERATIVE MODEL TO RESPOND TO a USER QUERY

One of a plurality of generative models 124 may be selected to generate a response to a query received from a user. An appropriate generative model 124 may be selected using micro-Large Language Models (micro-LLMs) or machine learning models 123. Micro-LLMs 123 may determine a topic and subtopic categorization of a user query, identify a knowledge source to use in generating the response (e.g., an LLM's general knowledge or the vector store 136), determine an appropriate prompt for generating the response, and select a generative model 124 to generate the response.

### Micro-Large Language Models

The micro-LLMs 123, or metamodels, may be lightweight machine learning or large language model that are fine-tuned to determine a topic and subtopic categorization of a user query, generate a prompt, select a generative model 124 for responding to a query, and perform other functionality to facilitate responding to a user query.

A micro-LLM 123 may be created using a foundation machine learning model 142 stored in the data store 133. The foundation machine learning models 142 may include general-purpose machine learning models trained on broad corpora of data. A micro-LLM 123 may use less processing power than the foundation machine learning model 142 used to create it, the latter of which may otherwise involve graphics processing units (GPUs) or high-performance central processing units (CPUs).

The foundation machine learning models 142 may be fine-tuned and parameter-pruned into a micro-LLM 123 that performs different functionality in the pipeline for generating a response to a query. For example, a foundation machine learning model 142 may be fine-tuned to a micro-LLM 123 that can perform quick searches to determine a topic categorization of a query. When fine-tuning a foundation machine learning model 142 to produce a micro-LLM 123 for a particular topic and subtopic, the foundation machine learning model 142 may be pruned of any components (e.g., neurons) that are not related to that topic and subtopic. As another example, a foundation machine learning model 142 may be fine-tuned to select an appropriate generative model 124 for generating a response to a query.

### Topic Categorization

The one or more micro-LLMs 123 may be used to make an inference to determine the topic and subtopic of a query. A micro-LLM 123 may, for example, employ a classifier such as a zero-shot classifier to categorize a query into one or more topics and subtopics, as well as determine a purpose and intent of the query. Metadata extracted from the query may also help to identify the query's topic and subtopic. The topics and subtopics into which a query can be categorized may be selected from a predefined set of possible topics and subtopics. To illustrate, a micro-LLM 123 may determine that the topic of the query “What are the risks of an appendectomy?” is “medical” with a sub-category of “surgical” and further sub-category of “abdominal surgery”.

Topic and subtopic categorization of queries may enable quicker and more accurate retrieval of data from the vector store 136. Only portions of the vector store 136 related to a query's topic and subtopic may be searched to retrieve information related to the query. Returning to the example above, only the portion of the vector store 136 associated with the “abdominal surgery” subtopic may be searched.

When making a selection (of topic and subtopic categorization or of a knowledge source), a micro-LLM 123 may output the top-k possible selections, where k may be a predefined value. And, together with each of the top-k possible selections, the micro-LLM 123 may calculate a confidence score or probability. The option with a highest confidence score may be selected. For example, when selecting a topic and subtopic for a query, the micro-LLM 123 may output k different possible topics or subtopics, calculate a confidence score for each of the k possible topics or subtopics, and select the possible topic and subtopic having the highest confidence score. And based on the confidence score for the top k topics and subtopics, the micro-LLM 123 may determine whether to have a selected generative model 124 generate a response using information from the vector store 136, or to have the selected generative model 124 generate a generic response using only knowledge derived from its training. If none of the top k topics and subtopics has a confidence score that meets or exceeds a predefined threshold, the selected generative model 124 may generate a generic response.

### Generating a PROMPT

A micro-LLM 123 may engineer prompts to use with the query to retrieve relevant information from the vector store 136 and generate an appropriate response. For example, the micro-LLM 123 may pre-process and rephrase the query to align with a template for generating a retrieval prompt used to retrieve data from the vector store 136. The micro-LLM 123 may pre-process and rephrase the query by modifying the query to align with the syntax of the template. The template may represent a predefined structure of a retrieval prompt that will enable the most efficient retrieval of information that is relevant to the query from the vector store 136. The micro-LLM 123 may apply the template to the pre-processed and rephrased query to create a retrieval prompt.

As another example, the micro-LLM 123 may generate a response prompt to increase the likelihood that a selected generative model 124 will generate a response that provides answer(s) to the query. The micro-LLM 123 may generate the response prompt based on, for example, the vector store metadata 139, metadata extracted from the query, and user-provided information. The micro-LLM 123 may apply this context together with an appropriate template to generate a response prompt.

### Selecting a Machine Learning Model

A micro-LLM 123 may be used to select a generative model 124 for generating a response to a query. While the machine learning model selected to generate a response is referred to herein as one of the generative models 124, a machine learning model operated by one of the external services 109 may be selected as appropriate.

The micro-LLM 123 may select the generative model 124 using one or more machine learning techniques like, for example, one-shot classification. The micro-LLM 123 may select a generative model 124 based on the query's topic and subtopic categorization and the vector store metadata 139 related to the data that was retrieved from the vector store 136. For example, the micro-LLM 123 may select the generative model 124 by checking a lookup table or other data structure to identify a generative model 124 that is appropriate for the query topic and subtopic. In some implementations, the micro-LLM 123 may select a generative model 124 (and hyperparameters, quantization level, and other settings of the generative model 124) further based on hardware, software, networking, and other environmental configurations of the accelerator cluster 103 to achieve a balance between accuracy and runtime.

In addition, the micro-LLM 123 may select appropriate hyperparameters for the selected generative model 124, a quantization level for the selected generative model 124, and other settings. The hyperparameters for the selected generative model 124 may be selected based on the semantic intent (i.e., the underlying meaning or purpose) of the query. For example, if the query requests “ideas for a science-fiction story”, the micro-LLM 123 may set a temperature hyperparameter for a selected generative model 124 to be relatively high, which may result in a creative response. On the other hand, if the query requests “sales figures for Company X in 2023”, then the micro-LLM 123 may set a temperature hyperparameter of a selected generative model 124 to be relatively low, which may result in a factual response.

In some examples, the query may specify values for various hyperparameters for the generative model 124 that will be used to generate a response to the query, a maximum output token limit for the response, and other configurations for generating the response.

### Generating a Response Using a Machine Learning Model

The one or more generative models 124 may be used to generate responses to queries. A generative model 124 may generate responses in multiple different modalities—e.g., natural language, image, audio, or video. In some implementations, the modality of a response may be automatically selected based on the user's query. The generative models 124 may include pre-trained machine learning models, fine-tuned machine learning models, or both. Different generative models 124 may have various different internal architectures and/or be trained on different corpora of training data.

The generative model 124 may generate a response based on the prompt. The prompt may be provided to the generative model 124, which may then generate a response in a selected modality. The generated response may then be provided to the database system 108, which may in turn provide the response to the database application 106.

In some implementations, the generative model 124 may be configured to provide responses eagerly. Because of the distributed, asynchronous nature of similarity computation involved in generating responses to queries, subsequent responses may emerge following an initial response that have greater similarity to the query. In some examples, this intermittent generation of responses may occur when an approximate k-nearest-neighbor search is used. Increasingly accurate responses may be generated as time elapses as information that is increasingly similar to the query is identified in the vector store 136.

The generative model 124 model may provide one or more preemptive or “fast” responses that can be generated quickly but may be less accurate, followed by one or more “accurate” responses that are more precise or better answer the query but may take more time to generate. As time elapses and more responses are generated and provided to the user (potentially with increasing accuracy), the provided responses may be re-ordered based on their similarity to the query. In some implementations, the generative model 124 may use two different algorithms-a “fast” algorithm and an “accurate” algorithm—to implement this functionality. In other implementations, the generative model 124 may reorder the provided responses based on similarity to the query when the responses are generated intermittently because of the distributed, asynchronous nature of the accelerator cluster 103.

### Example Process for Vector Store Generation

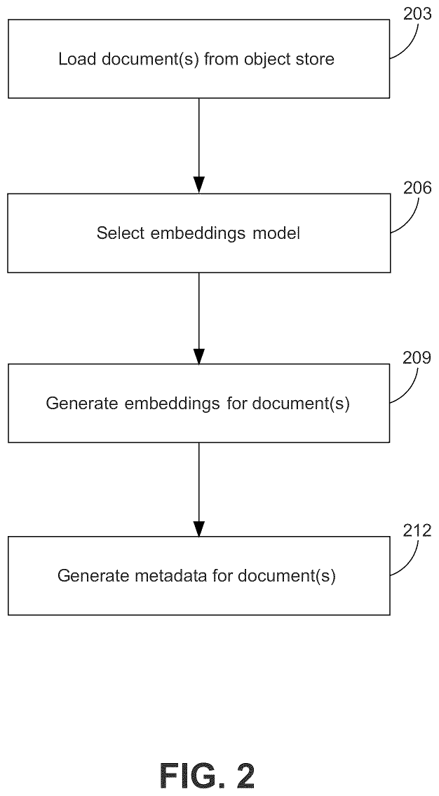

FIG. 2 is a flow diagram that depicts an example of the operation of a portion of the accelerator cluster 103, in an embodiment. The flow diagram of FIG. 2 provides merely an example of the many different types of functional arrangements that may be employed to implement the operation of the depicted portion of the accelerator cluster 103. As an alternative, the flow diagram of FIG. 2 may be viewed as depicting an example of elements of a method implemented within the network environment 100.

At step 203, the embeddings model selector 130 loads one or more documents from the object store 145. The one or more documents may include, for example, Portable Document Format (PDF) documents, rich text documents, handwritten text documents, images, audio recordings, and videos.

At step 206, the embeddings model selector 130 selects an embeddings model 127 to generate embeddings of the one or more documents. The embeddings model selector 130 selects an embeddings model 127 that supports a data type of the one or more documents, is pretrained on a topic and subtopic categorization of the one or more documents, and has a highest score according to a scoring metric. The embeddings model selector 130 identifies embeddings models 127 that can embed documents of the same data type as the one or more documents, like text, image, audio, or video data. From those embeddings models 127, the embeddings model selector 130 identifies which of those is pretrained on the topic and subtopic of the one or more documents. The embeddings model selector 130 scores each of the embeddings models 127 pretrained on the one or more documents' topic and subtopic and selects the embeddings model 127 with the highest score. The score can be based on reconstruction error for those embeddings models 127, which measures how well embeddings generated by each such embeddings model 127 can be reconstructed into the original one or more documents. The score can also be based on metadata for the one or more documents or on hardware, software, and environmental factors that could affect the performance of the embeddings models 127. The embeddings model selector 130 also selects hyperparameters for the selected embeddings model 127 based on similar factors.

At step 209, the selected embeddings model 127 generates embeddings for the one or more documents. The embeddings are stored in the vector store 136 based on their topic and subtopic categorization.

At step 212, selected embeddings model 127 generates vector store metadata 139. The selected embeddings model 127 extracts metadata and context from the one or more documents while generating the embeddings. The context and metadata extracted from the one or more documents can include summarizations of the one or more documents and/or segments of the one or more documents. The extracted context and metadata are stored in the vector store metadata 139 based on their topic and subtopic categorizations.

### Example Process for Generating a Response to a User Prompt

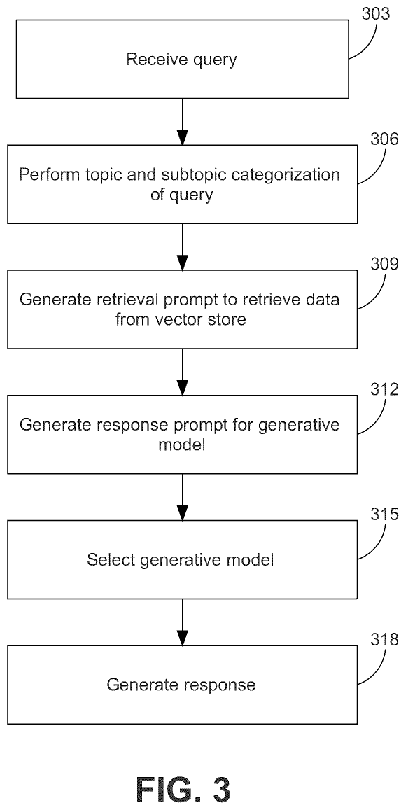

FIG. 3 is a flow diagram that depicts an example of the operation of a portion of the accelerator cluster 103, in an embodiment. The flow diagram of FIG. 3 provides merely an example of the many different types of functional arrangements that may be employed to implement the operation of the depicted portion of the accelerator cluster 103. As an alternative, the flow diagram of FIG. 3 may be viewed as depicting an example of elements of a method implemented within the network environment 100.

At step 303, the accelerator cluster 103 receives a query from a user. The query can originate from the database application 106 and passed to the accelerator cluster 103 by the database system 108.

At step 306, a micro-LLM 123 performs topic and subtopic categorization on the query. Before doing so, though, one of the embeddings models 127 can embed the query. The micro-LLM 123 determines a topic and a subtopic of the query. The micro-LLM 123 may be fine-tuned for topic and subtopic categorization. For example, the micro-LLM 123 may classify the query into one of a plurality of predefined categories to determine a topic and subtopic of the query. The micro-LLM 123 may determine whether a selected generative model 124 will generate the response using its own general knowledge or data stored in the vector store 136.

At step 309, a micro-LLM 123 generates a retrieval prompt to retrieve data from the vector store 136. The micro-LLM 123 pre-processes and rephrases the query to align with a template for the retrieval prompt. The micro-LLM 123 applies the template to the pre-processed and rephrased query to generate the retrieval prompt.

At step 312, a micro-LLM 123 generates a response prompt. The response prompt helps the selected generative model 124 to generate relative responses to the query. The micro-LLM 123 generates the prompt by applying a template to the query together with metadata from the query, vector store metadata 139, user-provided information, and potentially other context.

At step 315, a micro-LLM 123 selects a generative model 124 to generate a response to the query. The micro-LLM 123 selects the generative model 124 using one or more machine learning techniques like one-shot classification. The micro-LLM 123 selects a generative model 124 based on the query's topic and subtopic categorization and the vector store metadata 139 related to the data that was retrieved from the vector store 136. The micro-LLM's 123 selection can also be based on hardware, software, networking, and other environmental configurations of the accelerator cluster 103 to achieve a balance between accuracy and runtime. The micro-LLM 123 also selects appropriate hyperparameters for the selected generative model 124, a quantization level for the selected generative model 124, and other settings.

At step 318, the selected generative model 124 generates the response. The generative model 124 may generate a response based on the response prompt. The generated response may then be provided to the database system 108, which may in turn provide the response to the database application 106. In some implementations, the selected generative model 124 may intermittently generate responses (because of the distributed, asynchronous nature of the accelerator cluster 103) and provide those responses eagerly. The generative model 124 model may generate and provide one or more initial responses quickly, but those responses may be less accurate. Subsequent responses may be increasingly accurate and better answer the query, but those responses may take more time to generate. The provided responses may be re-ordered based on their similarity to the query as more are provided to the user. In some implementations, the generative model 124 uses a “fast” algorithm to quickly generate the initial responses, while the generative model 124 uses an “accurate” algorithm to generate the more accurate subsequent responses. In some implementations, the generative model 124 may reorder the provided responses based on similarity to the query when the responses are generated.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

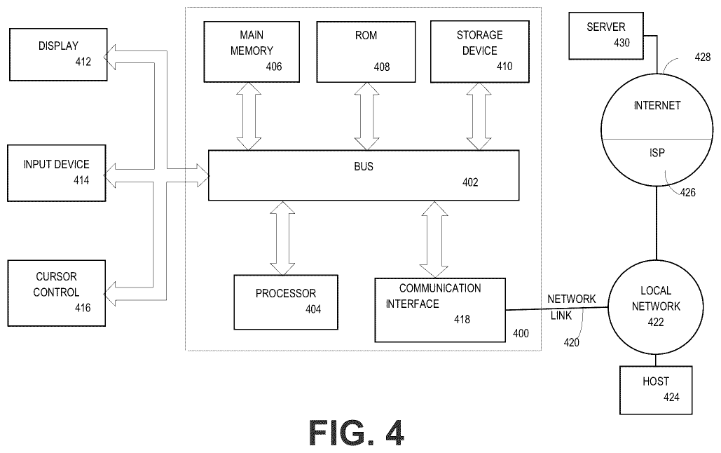

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Software Overview

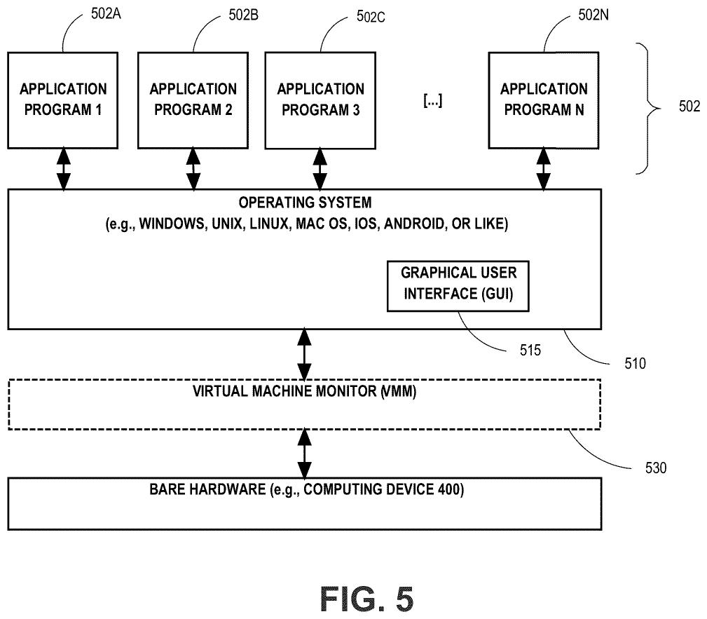

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 500 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a user query;
determining a categorization of the user query;
selecting one of a plurality of machine learning models based at least in part on the categorization of the user query;
generating a prompt based at least in part on the user query; and
generating, using the one of the plurality of machine learning models, a response to the user query based at least in part on the prompt;
wherein the method is performed by one or more computing devices.

2. The method of claim 1, wherein the categorization of the user query is determined using a micro machine learning model.

3. The method of claim 1, wherein the response is a first response, the method further comprising:
generating, using the one of the plurality of machine learning models, a second response to the user query based at least in part on the prompt, the second response being a more accurate to the user query than the first response.

4. The method of claim 1, wherein generating, using the one of the plurality of machine learning models, the response to the user query based at least in part on the prompt further comprises:
performing a similarity search of a vector store using the prompt;
retrieving data relevant to the prompt from the vector store;
generating an enhanced prompt based on the data relevant to the prompt;
generating, using the one of the plurality of machine learning models, the response based on the enhanced prompt.

5. The method of claim 4, further comprising performing the similarity search of a portion of the vector store corresponding to the categorization of the user query.

6. The method of claim 1, wherein the one of the plurality of machine learning models is selected using a zero-shot classifier.

7. A method comprising:
obtaining a digital artifact;
selecting one of a plurality of embeddings models;
generating an embedding for the digital artifact using the one of the plurality of embeddings models;
generating metadata for the digital artifact; and
storing the embedding in a vector store in association with the metadata;
wherein the method is performed by one or more computing devices.

8. The method of claim 7, further comprising selecting an embedding modality for generating the embedding for the digital artifact.

9. The method of claim 7, wherein the metadata comprises a categorization of the digital artifact.

10. The method of claim 7, wherein the one of the plurality of embeddings models is selected based at least in part on a classification of the digital artifact.

11. The method of claim 7, wherein the metadata for the digital artifact is generated using a one-shot classifier.

12. One or more non-transitory storage media storing instructions which, when executed by one or more computing devices, cause:
receiving a user query;
determining a categorization of the user query;
selecting one of a plurality of machine learning models based at least in part on the categorization of the user query;
generating a prompt based at least in part on the user query; and
generating, using the one of the plurality of machine learning models, a response to the user query based at least in part on the prompt.

13. The one or more non-transitory storage media of claim 12, wherein the categorization of the user query is determined using a micro machine learning model.

14. The one or more non-transitory storage media of claim 12, wherein the response is a first response, the method further comprising:
generating, using the one of the plurality of machine learning models, a second response to the user query based at least in part on the prompt, the second response being a more accurate to the user query than the first response.

15. The one or more non-transitory storage media of claim 12, wherein generating, using the one of the plurality of machine learning models, the response to the user query based at least in part on the prompt further comprises:
performing a similarity search of a vector store using the prompt;
retrieving data relevant to the prompt from the vector store;
generating an enhanced prompt based on the data relevant to the prompt;
generating, using the one of the plurality of machine learning models, the response based on the enhanced prompt.

16. The one or more non-transitory storage media of claim 15, further comprising performing the similarity search of a portion of the vector store corresponding to the categorization of the user query.

17. The one or more non-transitory storage media of claim 12, wherein the one of the plurality of machine learning models is selected using a zero-shot classifier.

18. One or more non-transitory storage media storing instructions which, when executed by one or more computing devices, cause:
obtaining a digital artifact;
selecting one of a plurality of embeddings models;
generating an embedding for the digital artifact using the one of the plurality of embeddings models;
generating metadata for the digital artifact; and
storing the embedding in a vector store in association with the metadata;
wherein the method is performed by one or more computing devices.

19. The one or more non-transitory storage media of claim 18, further comprising selecting an embedding modality for generating the embedding for the digital artifact.

20. The one or more non-transitory storage media of claim 18, wherein the metadata comprises a categorization of the digital artifact.

21. The one or more non-transitory storage media of claim 18, wherein the one of the plurality of embeddings models is selected based at least in part on a classification of the digital artifact.

22. The one or more non-transitory storage media of claim 18, wherein the metadata for the digital artifact is generated using a one-shot classifier.
